(19) United States
(12) Patent Application Publication
(10) Pub. No.: US 2013/0281603 A1
(43) Pub. Date: Oct. 24, 2013

(54) Thermoplastic Resin Composition with Improved Cloudy White Phenomenon at Low Temperatures

(71) Applicant: Cheil Industries Inc., Gumi-si (KR)

(72) Inventors: Sung Hun Jin, Uiwang-si (KR); Chang Do Jung, Uiwang-si (KR); Bang Duk Kim, Uiwang-si (KR); Jun Hong Park, Uiwang-si (KR)

(21) Appl. No.: 13/924,863

(22) Filed: Jun. 24, 2013

Related U.S. Application Data
(63) Continuation-in-part of application No. PCT/KR2011/008966, filed on Nov. 23, 2011.

(30) Foreign Application Priority Data
Dec. 31, 2010 (KR) 10-2010-0140291
Nov. 22, 2011 (KR) 10-2011-0122132

(51) Int. Cl. C08L 51/00; C08L 33/12; C08L 33/20

(52) U.S. Cl. CPC C08L 51/003; C08L 33/20; C08L 33/12
USPC 524/504; 525/64

(57) ABSTRACT

A thermoplastic resin composition comprises: (A) a graft copolymer resin comprising a core comprising a rubber polymer; and a shell formed by graft polymerization of acrylic acid alkyl ester monomer and/or methacrylic acid alkyl ester monomer, unsaturated nitrile monomer, and aromatic vinyl monomer on the surface of the core; (B) a non-graft copolymer resin comprising a copolymer which is formed by polymerizing acrylic acid alkyl ester monomer and/or methacrylic acid alkyl ester monomer, aromatic vinyl monomer, and unsaturated nitrile monomer; and a (co)polymer which is formed by polymerizing acrylic acid alkyl ester monomer, methacrylic acid alkyl ester monomer or a combination thereof; and (C) a siloxane impact reinforcing agent. The composition can have excellent impact strength and scratch resistance, and exhibits reduced or no cloudy white phenomenon at a low temperature.

### CROSS-REFERENCE TO RELATED APPLICATIONS

This application is a continuation-in-part of International Application No. PCT/KR2011/008966, filed Nov. 23, 2011, pending, which designates the U.S., published as WO2012/091296, and is incorporated herein by reference in its entirety, and claims priority therefrom under 35 USC Section 120. This application also claims priority under 35 USC Section 119 from Korean Patent Application No. 10-2010-0140291, filed Dec. 31, 2010, and Korean Patent Application No. 10-2011-0122132, filed Nov. 22, 2011, the entire disclosure of each of which is also incorporated herein by reference.

### FIELD OF THE INVENTION

The present invention relates to a thermoplastic resin composition which can exhibit minimal or no cloudy white phenomenon at a low temperature.

### BACKGROUND OF THE INVENTION

Acrylonitrile-butadiene rubber-styrene (ABS) generally has good impact resistance, processability, mechanical strength, heat distortion temperature and gloss. Therefore, the resin has been widely used in the manufacture of electric or electronic goods, office automation instruments, and the like. However, ABS resins used in the manufacture of electronic product housings for LCDs, PDPs, TVs, audio equipment, and the like, tend to show scratches as a result of injection molding or during normal usage. Further, it can be difficult to impact a desired color to the ABS resin, which can decrease its commercial value.

To avoid this problem, the surface of the molded ABS resin article can be coated with urethane, UV curable coating, or acrylic resin coating. However, these coating methods required post-processing treatment. This can complicate the manufacturing process and result in a high defect rate, which in turn can decrease productivity. Further, these coating methods can give rise to a problem of environmental contamination.

To avoid this problem, polymethylmethacrylate (PMMA) resin having excellent colorability and gloss has been used as scratch resistant materials that do not need urethane coating. However, PMMA resin has poor impact resistance and insufficient moldability, which can make injection molding difficult. Therefore, this material is generally extruded as a sheet and the extruded sheet is attached to a molded article. However, this method can be expensive and have a high defect rate due to post-processing steps.

Methyl methacrylate-acrylonitrile-butadiene-styrene resin (g-MABS or so-called ‘transparent ABS resin’) can also be used as a scratch resistant material. Although the transparent ABS resin can have good colorability, gloss, and impact resistance, it does not have sufficient scratch properties such as R-hardness and flexural modulus. Accordingly, the material can warp or bend during a molding process.

Further, ABS/PMMA alloy can have poor colorability and may not have sufficient scratch resistance, although it can have good impact resistance.

In order to solve these problems, Korean Patent No. 10-2007-0108008 discloses a resin composition having good scratch resistance comprising a graft reinforcing agent (g-MAB) with a core-shell structure including (meth)acrylic acid alkyl ester in its outer shell and a resin including (meth)acrylic acid alkyl ester, so that other physical properties of the resin composition along with scratch resistance is improved.

There is increasing emphasis on providing flexibility of design (such as color) for home appliances and thus research has focused on developing techniques to impart color to resin compositions used to make such products. In the course of resin development, however, a cloudy white phenomenon at low temperatures is a problem. For example, the resin composition having good scratch resistance disclosed in Korean Patent No. 10-2007-0108008 can have this cloudy white problem.

Also, siloxane impact reinforcing agents such as polydimethylsiloxane are used to improve the impact strength of MABS/PMMA alloy resins. However, when siloxane impact reinforcing agents are used, micro-pores can form inside the resin, which can aggravate the cloudy white phenomenon.

Further, in order to implement the design of flat panel TVs such as LED TVs, the molded articles are becoming thinner, and ultimately transmission of the molded article becomes higher. Therefore, there is a need for a resin composition which does not change color when used to manufacture such products.

### SUMMARY OF THE INVENTION

The present invention provides a thermoplastic resin composition that can minimize (or exhibit improvements in) the cloudy white phenomenon at a low temperature.

The present invention also provides a thermoplastic resin composition that can have excellent impact strength.

The present invention further provides a thermoplastic resin composition that can have excellent scratch resistance.

A thermoplastic resin composition according to the present invention comprises: (A) a graft copolymer resin comprises a core comprising a rubber polymer; and a shell formed by graft polymerization of acrylic acid alkyl ester monomer and/or methacrylic acid alkyl ester monomer, unsaturated nitrile monomer, and aromatic vinyl monomer on surface of the core; (B) a non-graft copolymer resin comprising a copolymer which is prepared by polymerizing acrylic acid alkyl ester monomer and/or methacrylic acid alkyl ester monomer, aromatic vinyl monomer, and unsaturated nitrile monomer, and a (co)polymer which is prepared by polymerizing acrylic acid alkyl ester monomer, methacrylic acid alkyl ester monomer or a combination thereof; and (C) a siloxane impact reinforcing agent; wherein the graft copolymer resin (A) comprises a first graft copolymer resin including a rubber polymer with an average particle size of about 0.18 to about 0.30 μm, a second graft copolymer including a rubber polymer with an average particle size of about 0.10 to about 0.17 μm, or a combination thereof.

In one embodiment of the present invention, the thermoplastic resin composition includes the graft copolymer resin (A) in an amount of about 30 to about 50 parts by weight; the non-graft copolymer resin (B) in an amount of about 50 to about 75 parts by weight; and the siloxane impact reinforcement agent (C) in an amount of about 0.001 to about 0.01 parts by weight, based on the total weight of (A), (B), and (C). In one embodiment of the present invention, the graft copolymer resin (A) includes the first graft copolymer resin in an amount of about 60 to about 99% by weight; and the second graft copolymer in an amount of about 1 to about 40% by weight, based on the total weight (100% by weight) of the graft copolymer resin (A).

In one embodiment of the present invention, the rubber polymer includes butadiene rubber, acrylic rubber, ethylene-propylene copolymer rubber, butadiene-styrene copolymer rubber, acrylonitrile-butadiene copolymer rubber, isoprene rubber, ethylene-propylene-diene terpolymer rubber, polyorganosiloxane-polyalkyl(meth)acrylate rubber complex, or a combination thereof.

In one embodiment of the present invention, the shell comprises an inner shell and an outer shell, wherein the outer shell includes a unit derived from an acrylic acid alkyl ester monomer and/or methacrylic acid alkyl ester monomer.

In one embodiment of the present invention, the inner shell is obtained through polymerization of the unsaturated nitrile monomer and the aromatic vinyl monomer, and the outer shell is obtained through polymerization of the acrylic acid alkyl ester monomer, the methacrylic acid alkyl ester monomer, or a combination thereof.

In another embodiment of the present invention, the inner shell is obtained through polymerization of the acrylic acid alkyl ester monomer and/or the methacrylic acid alkyl ester monomer, the unsaturated nitrile monomer and the aromatic vinyl monomer, and the outer shell is obtained through polymerization of the acrylic acid alkyl ester monomer and/or the methacrylic acid alkyl ester monomer, the unsaturated nitrile monomer and the aromatic vinyl monomer.

In one embodiment of the present invention, the graft copolymer resin (A) comprises the core in an amount of about 30 to about 70% by weight; a unit derived from the acrylic acid alkyl ester monomer and/or methacrylic acid alkyl ester monomer in an amount of about 15 to about 55% by weight; a unit derived from the unsaturated nitrile monomer in an amount of about 1 to about 5% by weight; and a unit derived from the aromatic vinyl monomer in an amount of about 5 to about 35% by weight, based on the total weight (100% by weight) of the graft copolymer resin (A).

In one embodiment of the present invention, the graft copolymer resin (A) is a methyl methacrylate-acrylonitrile-butadiene-styrene graft copolymer.

In one embodiment of the present invention, the degree of grafting of the graft copolymer resin (A) is about 30 to about 70%.

In one embodiment of the present invention, the copolymer of the non-graft copolymer resin (B) which is formed by polymerizing the acrylic acid alkyl ester monomer and/or methacrylic acid alkyl ester monomer, aromatic vinyl monomer, and unsaturated nitrile monomer is methyl methacrylate-styrene-acrylonitrile copolymer, and the (co)polymer of the non-graft copolymer resin (B) which is formed by polymerizing the acrylic acid alkyl ester monomer, methacrylic acid alkyl ester monomer, or a combination thereof is polymethyl methacrylate.

In one embodiment of the present invention, the methyl methacrylate-styrene-acrylonitrile copolymer comprises a methyl methacrylate-styrene-acrylonitrile copolymer with low fluidity which has a weight-average molecular weight of about more than 100,000 g/mol and about 150,000 g/mol or less and a methyl methacrylate-styrene-acrylonitrile copolymer with high fluidity which has a weight-average molecular weight of about 50,000 to about 100,000 g/mol.

In one embodiment of the present invention, the non-graft copolymer resin (B) comprises the methyl methacrylate-styrene-acrylonitrile copolymer in an amount of about 50 to about 99% by weight and the polymethylmethacrylate in an amount of about 1 to about 50% by weight, based on the total weight (100% by weight) of the non-graft copolymer resin (B).

In one embodiment of the present invention, the non-graft copolymer resin (B) comprises the low fluidity methyl methacrylate-styrene-acrylonitrile copolymer in an amount of about 30 to about 90% by weight; the high fluidity methyl methacrylate-styrene-acrylonitrile copolymer in an amount of about 5 to about 50% by weight; and the polymethylmethacrylate in an amount of about 1 to about 30% by weight, based on the total weight (100% by weight) of the non-graft copolymer resin (B).

In one embodiment of the present invention, the siloxane impact reinforcing agent (C) includes polydimethylsiloxane, polymethylphenylsiloxane, polydiphenylsiloxane, or a combination thereof.

In one embodiment of the present invention, the viscosity of the siloxane impact reinforcing agent is about 40 to about 150 cp.

In one embodiment of the present invention, the thermoplastic resin composition further includes an additive selected from the group consisting of dyes, pigments, antioxidants, flame retardants, fillers, stabilizers, lubricants, antimicrobial agents, release agents, carbon black, and combinations thereof.

In one embodiment of the present invention, the thermoplastic resin composition has a Notch Izod impact strength of about 15 to about 20 kgf·cm/cm, wherein the Notch Izod impact strength is measured for a specimen with a 3.715 mm thickness in accordance with ASTM D256.

In one embodiment of the present invention, the thermoplastic resin composition has a melt flow index of about 8 to about 20 g/10 min, wherein the melt flow index is measured in accordance with ISO 1103 at 220° C. and a 10 kg load.

In one embodiment of the present invention, the thermoplastic resin composition has a R-hardness of about 100 to about 110, wherein the R-hardness is measured in accordance with ASTM D785.

The thermoplastic resin composition according to the present invention not only can have excellent impact strength and/or scratch resistance, but also can display minimal or no cloudy white phenomenon at a low temperature.

### DETAILED DESCRIPTION OF THE INVENTION

The present invention now will be described more fully hereinafter in the following detailed description of the invention in which some but not all embodiments of the invention are described. Indeed, this invention may be embodied in many different forms and should not be construed as limited to the embodiments set forth herein; rather, these embodiments are provided so that this disclosure will satisfy applicable legal requirements.

A thermoplastic resin composition according to the present invention comprises: (A) a graft copolymer resin comprising a core comprising a rubber polymer; and a shell formed by graft polymerization of acrylic acid alkyl ester monomer and/or methacrylic acid alkyl ester monomer, unsaturated nitrile monomer, and aromatic vinyl monomer on a surface of the core; (B) a non-graft copolymer resin comprising a copolymer which is formed by polymerizing acrylic acid alkyl ester monomer and/or methacrylic acid alkyl ester monomer, aromatic vinyl monomer, and unsaturated nitrile monomer, and a (co)polymer which is formed by polymerizing acrylic acid alkyl ester monomer, methacrylic acid alkyl ester monomer or a combination thereof; and (C) a siloxane impact reinforcing agent; wherein the graft copolymer resin (A) comprises a first graft copolymer resin including a rubber polymer with an average particle size of about 0.18 to about 0.30 μm, a second graft copolymer including a rubber polymer with an average particle size of about 0.10 to about 0.17 μm, or a combination thereof.

In exemplary embodiments of the present invention, the thermoplastic resin composition includes the graft copolymer resin (A) in an amount of about 30 to about 50 parts by weight; the non-graft copolymer resin (B) in an amount of about 50 to about 75 parts by weight; and the siloxane impact reinforcement agent (C) in an amount of about 0.001 to about 0.01 parts by weight, wherein each is based on the total weight of (A), (B), and (C).

(A) Graft Copolymer Resin

The graft copolymer (A) comprises a core; and a shell formed by graft polymerization on the surface of the core. The core comprises a rubber polymer, and the shell is formed by graft polymerization of acrylic acid alkyl ester monomer and/or methacrylic acid alkyl ester monomer, unsaturated nitrile monomer, and aromatic vinyl monomer.

Examples of the rubber polymer suitable for preparing the graft copolymer resin can include, without limitation, butadiene rubbers, acrylic rubbers, ethylene-propylene copolymer rubbers, butadiene-styrene copolymer rubbers, acrylonitrile-butadiene copolymer rubbers, isoprene rubbers, ethylene-propylene-diene terpolymer rubbers, polyorganosiloxane-polyalkyl(meth)acrylate rubber complexes, and the like. These polymers can be used singly or as a combination thereof. For example, butadiene rubber or butadiene-styrene copolymer rubber can be used. If the butadiene-styrene copolymer rubber is used, the butadiene-styrene copolymer rubber can include the styrene in an amount of less than about 30% by weight.

The acrylic acid alkyl ester monomer and/or methacrylic acid alkyl ester monomer are not specifically limited. In one embodiment of the present invention, examples of the acrylic acid alkyl ester monomer and/or methacrylic acid alkyl ester monomer can include without limitation C₁ to C₁₀ alkyl acrylates, C₁ to C₁₀ alkyl methacrylates, and the like, and combinations thereof.

Examples of the C₁ to C₁₀ alkyl acrylates can include, without limitation, methyl acrylate, ethyl acrylate, propyl acrylate, isopropyl acrylate, t-butyl acrylate, n-butyl acrylate, n-octyl acrylate, 2-ethylhexylacrylate, and the like, and combinations thereof. Examples of the C₁ to C₁₀ alkyl methacrylates can include, without limitation, methyl methacrylate, ethyl methacrylate, propyl methacrylate, isopropyl methacrylate, t-butyl methacrylate, n-butyl methacrylate, n-octyl methacrylate, 2-ethylhexyl methacrylate, and the like, and combinations thereof. For example, methyl methacrylate can be used.

The unsaturated nitrile monomer is a compound comprising both an unsaturated hydrocarbon and cyanide group which can be radically polymerized, and the type of this monomer is not specifically limited. Examples of the unsaturated nitrile monomer can include, without limitation, acrylonitrile, methacrylonitrile, ethacrylonitrile, and the like, and combinations thereof. These can be used singly or as a combination thereof. For example, acrylonitrile can be used.

The type of the aromatic vinyl monomer is not specifically limited. Examples of the aromatic vinyl monomer can include, without limitation, styrene, C₁ to C₁₀ alkyl substituted styrenes, halogen substituted styrenes, vinyl naphthalene, and the like, and combinations thereof. These can be used singly or as a combination thereof.

In one embodiment of the present invention, examples of the aromatic vinyl monomer can include without limitation styrene, C₁ to C₁₀ alkyl substituted styrenes wherein a hydrogen atom of the vinyl group is substituted, C₁ to C₁₀ alkyl substituted styrenes wherein a hydrogen atom of the benzene group is substituted, halogen substituted styrenes wherein a hydrogen atom of the vinyl group is substituted, halogen substituted styrenes wherein a hydrogen atom of the benzene group is substituted, vinyl naphthalene, and the like, and combinations thereof.

In one embodiment of the present invention, examples of the aromatic vinyl monomer can include without limitation styrene, α-methyl styrene, β-methyl styrene, o-methyl styrene, m-methyl styrene, ρ-methyl styrene, o-ethyl styrene, m-ethyl styrene, ρ-ethyl styrene, propyl styrene, butyl styrene, monochlorostyrene, dichlorostyrene, trichlorostyrene, 1-vinylnaphthalene, 2-vinylnaphthalene, and the like, and combinations thereof.

For example, styrene can be used.

The shell can further include one or more additional monomers. Examples of additional monomers can include, without limitation, anhydrous maleic anhydride, C₁ to C₄ alkyl and/or phenyl substituted maleimides, and the like, and combinations thereof.

The shell can include an inner shell and an outer shell. The outer shell can include units derived from acrylic acid alkyl ester monomer and/or methacrylic acid alkyl ester monomer. In this case, the inner shell can improve the impact strength, and the outer shell can improve scratch resistance.

In exemplary embodiments, the inner shell can be obtained through polymerization of the unsaturated nitrile monomer and the aromatic vinyl monomer (for example, the inner shell can include styrene-acrylonitrile copolymer (SAN)), and the outer shell can be obtained through polymerization of the acrylic acid alkyl ester monomer, the methacrylic acid alkyl ester monomer, or a combination thereof (for example, the outer shell can include polymethyl methacrylate (PMMA)). In this case, an exemplary method for preparing the graft copolymer resin is described below.

On the surface of the core, aromatic vinyl monomer and unsaturated nitrile monomer can be polymerized to form an inner shell (the 1^{st} stage), and acrylic acid alkyl ester monomer and/or methacrylic acid alkyl ester monomer can be added to form an outer shell which encloses this inner shell (the 2^{nd} stage). The 1^{st} stage can be conducted using a fat soluble redox initiator system as known in the art, and the 2^{nd} stage can be conducted using a water soluble initiator system also as known in the art. The graft copolymer prepared after the 2^{nd} stage can be subject to post processing steps such as solidification, washing, and dehydration, and thereafter converted into powder form.

In other exemplary embodiments, the inner shell can be obtained through polymerization of the acrylic acid alkyl ester monomer and/or the methacrylic acid alkyl ester monomer, the unsaturated nitrile monomer and the aromatic vinyl monomer (for example, the inner shell can include methyl methacrylate-acrylonitrile-styrene copolymer (MSAN)), and the outer shell can be obtained through polymerization of the acrylic acid alkyl ester monomer and/or the methacrylic acid alkyl ester monomer, the unsaturated nitrile monomer and the aromatic vinyl monomer (for example, the outer shell can include methyl methacrylate-acrylonitrile-styrene copolymer (MSAN)). In this case, an exemplary method for preparing the graft copolymer is described below.

On the surface of the core, part of a mixture of acrylic acid alkyl ester monomer and/or methacrylic acid alkyl ester monomer, aromatic vinyl monomer and unsaturated nitrile monomer can be polymerized to form an inner shell (the 1st stage), and residual monomer mixture can be added to form an outer shell which encloses this inner shell (the 2^{nd} stage). The 1^{st} stage can be conducted using a fat soluble redox initiator system as known in the art, and the 2^{nd} stage can be conducted using a water soluble initiator system also as known in the art. The graft copolymer prepared after the 2^{nd} stage can be subject to post processing steps such as solidification, washing, and dehydration, and thereafter converted into powder form.

In the present invention, the graft copolymer resin can improve the colorability since the difference between the refractive index of the core and the shell is small. During preparation of the graft copolymer resin, acrylic acid alkyl ester monomer and/or methacrylic acid alkyl ester monomer can be positioned at the end of a chain, which can improve scratch resistance. Also, by enclosing the graft copolymer with acrylic acid alkyl ester monomer and/or methacrylic acid alkyl ester monomer (i.e., the acrylic acid alkyl ester monomer and/or methacrylic acid alkyl ester monomer can be present at the outermost surface of the core), weather resistance can be improved.

In one embodiment of the present invention, the graft copolymer resin (A) comprises the core in an amount of about 30 to about 70% by weight (for example, about 55% by weight), a unit derived from the acrylic acid alkyl ester monomer and/or methacrylic acid alkyl ester monomer in an amount of about 15 to about 55% by weight, a unit derived from the unsaturated nitrile monomer in an amount of about 1 to about 5% by weight, and a unit derived from the aromatic vinyl monomer in an amount of about 5 to about 35% by weight, wherein each is based on the total weight (100% by weight) of the graft copolymer resin (A).

In some embodiments, the graft copolymer resin (A) can include the core in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70% by weight. Further, according to some embodiments of the present invention, the core may be present in an amount of from about any of the foregoing amounts to about any other of the foregoing amounts.

In some embodiments, the graft copolymer resin (A) can include a unit derived from the acrylic acid alkyl ester monomer and/or methacrylic acid alkyl ester monomer in an amount of about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, or 55% by weight. Further, according to some embodiments of the present invention, the unit derived from the acrylic acid alkyl ester monomer and/or methacrylic acid alkyl ester monomer may be present in an amount of from about any of the foregoing amounts to about any other of the foregoing amounts.

In some embodiments, the graft copolymer resin (A) can include a unit derived from the unsaturated nitrile monomer in an amount of about 1, 2, 3, 4, or 5% by weight. Further, according to some embodiments of the present invention, the unit derived from the unsaturated nitrile monomer may be present in an amount of from about any of the foregoing amounts to about any other of the foregoing amounts.

In some embodiments, the graft copolymer resin (A) can include a unit derived from the aromatic vinyl monomer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35% by weight. Further, according to some embodiments of the present invention, the unit derived from the aromatic vinyl monomer may be present in an amount of from about any of the foregoing amounts to about any other of the foregoing amounts.

In one embodiment of the present invention, the graft copolymer resin (A) is methyl methacrylate-acrylonitrile-butadiene-styrene graft copolymer (g-MABS).

In one embodiment of the present invention, the degree of grafting of the graft copolymer resin (A) is about 30 to about 70%. In this case, white powder with uniform particle size during solidification and drying can be obtained, and the problem of impairing surface condition and gloss of molded article caused by non-plasticized particles during extrusion or injection can be minimized or eliminated. In addition, impact strength, moldability, and surface gloss can be excellently maintained.

In the present invention, the graft copolymer resin (A) can include a first graft copolymer resin in which the average particle size of the rubber polymer is about 0.18 to about 0.30 μm (for example, about 0.245 μm), a second graft copolymer resin in which the average particle size of the rubber polymer is about 0.10 to about 0.17 μm (for example, about 0.13 μm), or a combination thereof. For example, the graft copolymer resin (A) can include the first graft copolymer resin, the second graft copolymer resin, or a combination thereof. If the average particle size is within the above ranges, an adequate balance of impact strength, colorability, and gloss can be maintained.

In some embodiments, the first graft copolymer resin can include a rubber polymer with an average particle size of about 0.18, 0.19, 0.20, 0.21, 0.22, 0.23, 0.24, 0.25, 0.26, 0.27, 0.28, 0.29, or 0.30 μm. Further, according to some embodiments of the present invention, the first graft copolymer resin can include a rubber polymer with an average particle size from about any of the foregoing sizes to about any other of the foregoing sizes.

In some embodiments, the second graft copolymer resin can include a rubber polymer with an average particle size of about 0.10, 0.11, 0.12, 0.13, 0.14, 0.15, 0.16, or 0.17 μm. Further, according to some embodiments of the present invention, the second graft copolymer resin can include a rubber polymer with an average particle size from about any of the foregoing sizes to about any other of the foregoing sizes.

As used herein, average particle size refers to the particle size which is measured based on the extent of light scattering, which can be determined using techniques known in the art. Rubber particles having an average particle size as discussed herein are commercially available.

In one embodiment of the present invention, the graft copolymer resin (A) can include the first graft copolymer resin in an amount of about 60 to about 99% by weight, for example, about 80 to about 99% by weight, and the second graft copolymer in an amount of about 1 to about 40% by weight, for example, about 1 to about 20% by weight, based on the total weight (100% by weight) of the graft copolymer resin (A). For example, the graft copolymer resin (A) can include the first graft copolymer resin in an amount of about 83% by weight, about 84% by weight, or about 86% by weight, and the second graft copolymer resin in an amount of about 14% by weight, about 16% by weight, or about 17% by weight.

In some embodiments, the graft copolymer resin (A) can include the first graft copolymer resin in an amount of about 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% by weight. Further, according to some embodiments of the present invention, the first graft copolymer resin may be present in an amount of from about any of the foregoing amounts to about any other of the foregoing amounts.

In some embodiments, the graft copolymer resin (A) can include the second graft copolymer resin in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39 or 40% by weight. Further, according to some embodiments of the present invention, the second graft copolymer resin may be present in an amount of from about any of the foregoing amounts to about any other of the foregoing amounts.

When the graft copolymer resin (A) includes the first and second graft copolymers in amounts within the above ranges, the composition can exhibit good impact strength and scratch resistance and the cloudy white phenomenon at a low temperature can be improved.

In one embodiment of the present invention, the thermoplastic resin composition can include the graft copolymer resin (A) in an amount of about 30 to about 50 parts by weight, based on the total weight of (A), (B), and (C). For example, the thermoplastic resin composition can include the graft copolymer resin (A) in an amount of about 30 parts by weight, about 35 parts by weight, about 40 parts by weight, about 45 parts by weight, or about 50 parts by weight. In some embodiments, the thermoplastic resin composition includes the graft copolymer resin (A) in an amount of about 30, 31, 32, 33, 34, 35, 36, 37, 38, 39, 40, 41, 42, 43, 44, 45, 46, 47, 48, 49, or 50 parts by weight. Further, according to some embodiments of the present invention, the graft copolymer resin (A) may be present in an amount of from about any of the foregoing amounts to about any other of the foregoing amounts.

When the thermoplastic resin composition includes the graft copolymer resin (A) in an amount within the above range, the cloudy white phenomenon of the resin at a low temperature can be improved, without impairing other physical properties such as impact strength, scratch resistance, gloss, and/or colorability.

(B) Non-Graft Copolymer Resin

The non-graft copolymer resin (B) comprises a copolymer which is formed by polymerizing acrylic acid alkyl ester monomer and/or methacrylic acid alkyl ester monomer, aromatic vinyl monomer and unsaturated nitrile monomer, and a (co)polymer which is formed by polymerizing acrylic acid alkyl ester monomer, methacrylic acid alkyl ester monomer or a combination thereof.

In the present invention, non-graft copolymer resin (B) means a copolymer resin excluding a graft copolymer resin (does not include a rubber polymer). Examples of the non-graft copolymer can include, without limitation, alternating copolymer resins, random copolymer resins, block copolymer resins, and the like, and combinations thereof.

The acrylic acid alkyl ester monomer and/or methacrylic acid alkyl ester monomer are not specifically limited. In one embodiment of the present invention, examples of the acrylic acid alkyl ester monomer and/or methacrylate alkyl ester monomer can include without limitation C₁ to C₁₀ alkyl acrylates, C₁ to C₁₀ alkyl methacrylates, and the like, and combinations thereof.

Examples of the C₁ to C₁₀ alkyl acrylates can include, without limitation, methyl acrylate, ethyl acrylate, propyl acrylate, isopropyl acrylate, t-butyl acrylate, n-butyl acrylate, n-octyl acrylate, and 2-ethylhexyl acrylate and the like, and combinations thereof. Examples of the C₁ to C₁₀ alkyl methacrylates can include, without limitation, methyl methacrylate, ethyl methacrylate, propyl methacrylate, isopropyl methacrylate, t-butyl methacrylate, n-butyl methacrylate, and n-octyl methacrylate, 2-ethylhexyl methacrylate, and the like, and combinations thereof. For example, methyl methacrylate can be used.

The detailed types of the aromatic vinyl monomer are not specifically limited. Examples of the aromatic vinyl monomer can include, without limitation, C₁ to C₁₀ alkyl substituted styrenes, halogen substituted styrenes, vinyl naphthalene, and the like. These can be used singly or a combination thereof.

In one embodiment of the present invention, examples of the aromatic vinyl monomer can include without limitation styrene, C₁ to C₁₀ alkyl substituted styrenes wherein a hydrogen atom of vinyl group is substituted, C₁ to C₁₀ alkyl substituted styrenes wherein a hydrogen atom of benzene group is substituted, halogen substituted styrenes wherein a hydrogen atom of the vinyl group is substituted, halogen substituted styrenes wherein a hydrogen atom of benzene group is substituted, vinyl naphthalene, and the like, and combinations thereof.

In one embodiment of the present invention, examples of the aromatic vinyl monomer can include without limitation styrene, α-methyl styrene, β-methyl styrene, o-methyl styrene, m-methyl styrene, ρ-methylstyrene, o-ethylstyrene, m-ethylstyrene, ρ-ethylstyrene, propylstyrene, butylstyrene, monochlorostyrene, dichlorostyrene, trichlorostyrene, 1-vinylnaphthalene, 2-vinylnaphthalene, and the like, and combinations thereof. In exemplary embodiments, styrene can be used as an aromatic vinyl monomer.

The unsaturated nitrile monomer is a compound comprising both an unsaturated hydrocarbon and cyanide group which can be radically polymerized, and the type of this monomer is not specifically limited. Examples of the unsaturated nitrile monomer can include, without limitation, acrylonitrile, methacrylonitrile, ethacrylonitrile, and the like. These can be used singly or as a combination thereof. For example, acrylonitrile can be used.

In one embodiment of the present invention, among the non-graft copolymer resins (B), the copolymer which is formed by polymerizing the acrylic acid alkyl ester monomer and/or methacrylic acid alkyl ester monomer, aromatic vinyl monomer and unsaturated nitrile monomer can be methyl methacrylate-styrene-acrylonitrile copolymer, and the polymer or copolymer which is formed by polymerizing the acrylic acid alkyl ester monomer, methacrylic acid alkyl ester monomer, or a combination thereof can be polymethylmethacrylate.

In one embodiment of the present invention, the methyl methacrylate-styrene-acrylonitrile copolymer comprises a methyl methacrylate-styrene-acrylonitrile copolymer of low fluidity which has a weight-average molecular weight of about more than 100,000 g/mol and about 150,000 g/mol or less and a methyl methacrylate-styrene-acrylonitrile copolymer of high fluidity which has a weight-average molecular weight of about 50,000 to about 100,000 g/mol. For example, the low fluidity methyl methacrylate-styrene-acrylonitrile copolymer can have a weight-average molecular weight of about 120,000 g/mol, and the high fluidity methyl methacrylate-styrene-acrylonitrile copolymer can have a weight-average molecular weight of about 85,000 g/mol. In this case, injection molding processability of the resin can be further improved.

In one embodiment, the non-graft copolymer resin (B) can include methyl methacrylate-styrene-acrylonitrile copolymer in an amount of about 50 to about 99% by weight, for example about 75 to about 95% by weight, and polymethylmethacrylate in an amount of about 1 to about 50% by weight, for example about 5 to about 25% by weight, based on the total weight (100% by weight) of the non-graft copolymer resin (B). For example, the non-graft copolymer resin (B) can include the methyl methacrylate-styrene-acrylonitrile copolymer in an amount of about 80% by weight, about 85% by weight, about 86% by weight, and about 87% by weight, and the non-graft copolymer resin (B) can include the polymethylmethacrylate in an amount of about 13% by weight, about 14% by weight, about 15% by weight, or about 20% by weight.

In some embodiments, the non-graft copolymer resin (B) can include methyl methacrylate-styrene-acrylonitrile copolymer in an amount of about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99% by weight. Further, according to some embodiments of the present invention, the methyl methacrylate-styrene-acrylonitrile copolymer may be present in an amount of from about any of the foregoing amounts to about any other of the foregoing amounts.

In some embodiments, the non-graft copolymer resin (B) can include polymethylmethacrylate in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the polymethylmethacrylate may be present in an amount of from about any of the foregoing amounts to about any other of the foregoing amounts.

In one embodiment of the present invention, the non-graft copolymer resin (B) can comprise the low fluidity methyl methacrylate-styrene-acrylonitrile copolymer in an amount of about 30 to about 90% by weight, for example about 50 to about 70% by weight, the high fluidity methyl methacrylate-styrene-acrylonitrile copolymer in an amount of about 5 to about 50% by weight, for example about 15 to about 35% by weight, and the polymethylmethacrylate in an amount of about 1 to about 30% by weight, for example about 5 to about 25% by weight, wherein the amount of each is based on the total weight (100% by weight) of the non-graft copolymer resin (B). For example, the non-graft copolymer resin (B) can include the low fluidity methyl methacrylate-styrene-acrylonitrile copolymer in an amount of about 53% by weight, about 57% by weight, about 60% by weight, or about 69% by weight. In addition, the non-graft copolymer resin (B) can include the high fluidity methyl methacrylate-styrene-acrylonitrile copolymer in an amount of about 15% by weight, about 20% by weight, about 29% by weight or about 33% by weight. In addition, the non-graft copolymer resin (B) can include the polymethylmethacrylate in an amount of about 13% by weight, about 14% by weight, about 15% by weight, or about 20% by weight.

In some embodiments, the non-graft copolymer resin (B) can include the low fluidity methyl methacrylate-styrene-acrylonitrile copolymer in an amount of about 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or 90% by weight. Further, according to some embodiments of the present invention, the low fluidity methyl methacrylate-styrene-acrylonitrile copolymer may be present in an amount of from about any of the foregoing amounts to about any other of the foregoing amounts.

In some embodiments, the non-graft copolymer resin (B) can include the high fluidity methyl methacrylate-styrene-acrylonitrile copolymer in an amount of about 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight. Further, according to some embodiments of the present invention, the high fluidity methyl methacrylate-styrene-acrylonitrile copolymer may be present in an amount of from about any of the foregoing amounts to about any other of the foregoing amounts.

In some embodiments, the non-graft copolymer resin (B) can include the polymethylmethacrylate in an amount of about 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30% by weight. Further, according to some embodiments of the present invention, the polymethylmethacrylate may be present in an amount of from about any of the foregoing amounts to about any other of the foregoing amounts.

In one embodiment of the present invention, the non-graft copolymer resin (B) can further comprise a copolymer which is formed by polymerizing the acrylic acid alkyl ester monomer and/or methacrylic acid alkyl ester monomer, and the aromatic vinyl monomer (for example, the non-graft copolymer resin (B) can further include methyl methacrylate-styrene copolymer).

In one embodiment of the present invention, the acrylic acid alkyl ester monomer and/or methacrylic acid alkyl ester monomer can be used in an amount of about 40% by weight to about 100% by weight, based on the total weight (100% by weight) of the non-graft copolymer resin (B). In some embodiments, the non-graft copolymer resin (B) can include the acrylic acid alkyl ester monomer and/or methacrylic acid alkyl ester monomer in an amount of about 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100% by weight. Further, according to some embodiments of the present invention, the acrylic acid alkyl ester monomer and/or methacrylic acid alkyl ester monomer may be present in an amount of from about any of the foregoing amounts to about any other of the foregoing amounts.

In this case, gloss, scratch resistance, colorability, and/or weather resistance can be excellently maintained.

In one embodiment of the present invention, the thermoplastic resin composition can include the non-graft copolymer resin (B) in an amount of about 50 to about 75 parts by weight, based on the total weight of (A), (B), and (C). In some embodiments, the thermoplastic resin composition includes the non-graft copolymer resin (B) in an amount of about 50, 51, 52, 53, 54, 55, 56, 57, 58, 59, 60, 61, 62, 63, 64, 65, 66, 67, 68, 69, 70, 71, 72, 73, 74, or 75 parts by weight. Further, according to some embodiments of the present invention, the non-graft copolymer resin (B) may be present in an amount of from about any of the foregoing amounts to about any other of the foregoing amounts.

When the thermoplastic resin composition includes the non-graft copolymer resin (B) in an amount within the above range, the cloudy white phenomenon of the resin composition at a low temperature can be improved, without impairing other physical properties such as impact strength, scratch resistance, gloss, and/or colorability.

(C) Siloxane Impact Reinforcing Agent

Examples of the siloxane impact reinforcing agents can include, without limitation, polydimethylsiloxane, polymethylphenylsiloxane, polydiphenylsiloxane, and the like. These can be used as singly or as a combination thereof.

In one embodiment of the present invention, a viscosity of the siloxane impact reinforcing agent can be about 40 to about 150 cp, for example about 70 to about 120 cp. For example, the viscosity of the siloxane impact reinforcing agent can be about 90 to about 100 cp. In this case, impact strength of the resin can be improved.

In one embodiment of the present invention, the thermoplastic resin composition can include the siloxane impact reinforcing agent in an amount of about 0.001 to about 0.01 parts by weight, for example about 0.002 to about 0.007 parts by weight, and as another example about 0.005 parts by weight, based on the total weight of (A), (B) and (C). In some embodiments, the thermoplastic resin composition includes the siloxane impact reinforcement agent (C) in an amount of about 0.001, 0.002, 0.003, 0.004, 0.005, 0.006, 0.007, 0.008, 0.009, or 0.01 parts by weight. Further, according to some embodiments of the present invention, the siloxane impact reinforcement agent (C) may be present in an amount of from about any of the foregoing amounts to about any other of the foregoing amounts.

Including the siloxane impact reinforcing agent in an amount within the above range can minimize or eliminate the cloudy white phenomenon at a low temperature and impact strength can be improved.

(D) Additives

In one embodiment of the present invention, the thermoplastic resin composition can further include one or more additives.

Examples of the additives can include, without limitation, dyes, pigments, antioxidants, flame retardants, fillers, stabilizers, lubricants, antimicrobial agents, releasing agents, carbon black, and the like. These can be used singly or as a combination thereof.

Examples of the antioxidants can include, without limitation, phenol antioxidants, phosphorus compounds, thioester compounds, and the like, and combinations thereof. The thermoplastic resin composition can include antioxidant in an amount of about 0.1 to about 1.0 parts by weight, for example about 0.2 to about 0.4 parts by weight, and as another example about 0.3 parts by weight, based on about 100 parts by weight of (A)+(B)+(C). In this case, the composition can exhibit an antioxidant effect with minimal or no impact on other properties of the resin composition.

Examples of the flame retardants can include, without limitation, phosphorus flame retardants, halogen flame retardants, and the like, and combinations thereof. Examples of the phosphorus flame retardants can include, without limitation, red phosphorus, phosphates, phosphonates, phosphinates, phosphine oxides, phosphazenes, metallic salts thereof, and the like, and combinations thereof. Examples of the halogen flame retardants can include, without limitation, decabromo diphenyl ether, decabromo diphenyl ethane, tetrabromo bisphenol-A, tetrabromo bisphenol-A epoxy oligomer, octabromotrimethylphenyl indane, ethylene-bis-tetrabromophthalimide, tris(tribromophenol)triazine, brominated polystyrene, and the like, and combinations thereof. The thermoplastic resin composition can include flame retardant in an amount of about 10 to about 30 parts by weight, for example about 15 to about 25 parts by weight, based on about 100 parts by weight of (A)+(B)+(C). In this case, the composition can exhibit a flame retardant effect with minimal or no impact on other properties of the resin composition.

Examples of the fillers can include, without limitation, glass fibers, carbon fibers, silica, mica, alumina, clay, calcium carbonate, calcium sulfate, glass beads, and the like, and combinations thereof. The fillers can improve physical properties such as mechanical strength and heat resistance. The thermoplastic resin composition can include filler in an amount of about 10 to about 50 parts by weight, for example about 20 to about 40 parts by weight, based on about 100 parts by weight of (A)+(B)+(C). In this case, the composition can exhibit the benefits of the filler with minimal or no impact on other properties of the resin composition.

The stabilizers play a role of preventing decomposition (for example, thermal decomposition) of the thermoplastic resin composition and further improving overall physical properties of the resin composition such as surface smoothness and heat resistance. Examples of the stabilizer can include without limitation phosphoric acid; phosphorous acids such as 3,5-di-t-butyl-4-hydroxybenzylphosphonic acid; phosphorous acid esters, such as triphenylphosphite, trimethylphosphite, tri-isodesylphosphite, and tri-(2,4-di-t-butylphenyl) phosphate; other phosphorus compounds, such as hypophosphorous acid and polyphosphoric acid; acid phosphate esters, such as methylphosphate, dibutylphosphate, and monobutylphosphate; and the like, and combinations thereof. The thermoplastic resin composition can include a stabilizer in an amount of about 0.1 to about 1.0 parts by weight, for example about 0.2 to about 0.4 parts by weight, based on about 100 parts by weight of (A)+(B)+(C). In this case, the composition can exhibit a stabilizing effect exhibited with minimal or no impact on other properties of the resin composition.

The lubricants play a role in improving the processability of resin composition, smoothening the surface of the final product, and giving a gloss to the surface of the final product. Among these, inner lubricants reduce the viscosity of melted materials by penetrating into the polymer, and external lubricants reduce the extrusion load between melted materials of the resin composition inside the extruder and metal surface. Examples of the inner lubricants can include without limitation ethylene bis stearamide, L-C polyethylene wax, and the like, and combinations thereof. Examples of the external lubricants can include, without limitation, metal stearates, such as barium stearate, calcium stearate, and magnesium stearate, and the like, and combinations thereof. The thermoplastic resin composition can include lubricants in an amount of about 0.1 to about 3 parts by weight, for example about 0.2 to about 1.0 parts by weight, based on about 100 parts by weight of (A)+(B)+(C). For example, the inner lubricant can be included in an amount of about 0.2 parts by weight, and the external lubricant can be included in an amount of 0.3 parts by weight. In this case, the composition can exhibit the effect of the lubricating agent with minimal or no impact on other properties of the resin composition.

The antimicrobial agents refers to antimicrobial, antimycotic, germicidal, sterilant, and/or anti-bacterial agents. Examples of the antimicrobial agents can include without limitation oxides comprising transition metals, silicon, aluminum, alkali metals, alkali earth metals, and the like, and combination thereof; hydroxides; and the like, and combinations thereof. Examples of the transition metals can include without limitation zirconium, titanium, zinc, copper, and the like, and combinations thereof. The thermoplastic resin composition can include antimicrobial agents in an amount of about 0.1 to about 10 parts by weight, for example about 1.0 to about 3.0 parts by weight, based on about 100 parts by weight of (A)+(B)+(C). In this case, the composition can exhibit the effect of the antimicrobial agent with minimal or no impact on other physical properties of the resin composition.

Examples of the release agents can include without limitation polymers comprising fluorine, silicon oils, metal salts of stearic acid, metal salts of montanic acid, montanic acid ester waxes, polyethylene waxes, and the like, and combinations thereof. The thermoplastic resin composition can include release agents in an amount of about 0.1 to about 5.0 parts by weight, for example about 0.2 to about 2.0 parts by weight, based on about 100 parts by weight of (A)+(B)+(C). In this case, the composition can exhibit the effect of the release agent with minimal or no impact on other properties of the resin composition.

The carbon black can improve scratch resistance and abrasion resistance. Examples of the carbon black can include without limitation furnace black, thermal black, channel black, acetylene black, lamp black, and the like, and combinations thereof. Other examples include without limitation SAF (super abrasion furnace) black and/or ISAF (intermediate super abrasion furnace) black, which can provide excellent abrasion properties due to their small particle diameters. Also, the carbon black can be used as combinations thereof. The thermoplastic resin composition can include carbon black in an amount of about 0.1 to about 3.0 parts by weight, for example about 0.2 to about 2.0 parts by weight, based on about 100 parts by weight of (A)+(B)+(C). For example, the carbon black can be included in an amount of about 0.2 parts by weight. In this case, the effect of carbon black can be exhibited with minimal or no impact on other properties of the resin composition.

In one embodiment of the present invention, the thermoplastic resin composition can have a Notch Izod impact strength of about 15 to about 20 kgf·cm/cm, for example about 15 kgf·cm/cm, about 16 kgf·cm/cm, about 17 kgf·cm/cm, about 18 kgf·cm/cm, or about 19 kgf·cm/cm, wherein the Notch Izod impact strength is measured for a specimen with a 3.715 mm thickness in accordance with ASTM D256.

In one embodiment of the present invention, the thermoplastic resin composition can have a melt flow index of about 8 to about 20 g/10 min, for example about 8 g/10 min, about 11.5 g/10 min, about 12 g/10 min, about 14 g/10 min, or about 17 g/10 min, wherein the melt flow index is measured in accordance with ISO 1103 at 220° C. and a 10 kg load.

In one embodiment of the present invention, the thermoplastic resin composition can have a R-hardness of about 100 to about 110, for example, about 100, about 104, about 105, about 108, or about 109, wherein the R-hardness is measured in accordance with ASTM D785.

In one embodiment of the present invention, the thermoplastic resin composition can have a pencil hardness of HB or F, wherein the pencil hardness is measured in accordance with JIS K5401.

The thermoplastic resin composition according to the present invention can be prepared using conventional method. For example, the thermoplastic resin composition can be prepared in pellet form by mixing each component and other optionally additives at the same time and melting and extruding the mixture inside an extruder.

The thermoplastic resin composition according to the present invention can have excellent impact resistance, fluidity, scratch resistance, and/or transparency. In addition, the cloudy white phenomenon at a low temperature can be improved so that the thermoplastic resin composition can be used in the electric/electronic goods, automotive parts, and the like, which require high quality appearance at low temperature as well as at room temperature.

The present invention will be further realized by the following examples. However, the following examples are provided for the purpose of exemplifying this invention, and are not intended to limit the scope of protection of this invention.

### EXAMPLES AND COMPARATIVE EXAMPLES

### Examples

Each of the components of the compositions used in the examples and comparative examples is as described below.

(A-1) Graft Copolymer Resin

Methyl methacrylate-acrylonitrile-butadiene-styrene graft copolymer (Brand name: CHCM) with a butadiene content of 55% by weight and having an average particle size of rubber 0.245 μm from Cheil Industries is used.

(A-2) Graft Copolymer Resin

Methyl methacrylate-acrylonitrile-butadiene-styrene graft copolymer (Brand name: CHCS) with a butadiene content of 55% by weight and having an average particle size of rubber 0.13 μm from Cheil Industries is used.

(B-1) Non-Graft Copolymer Resin

Methyl methacrylate-acrylonitrile-styrene graft copolymer (Brand name: CM-5100) which has a weight-average molecular weight of 120,000 g/mol and a melt flow index of 10 g/10 min from Cheil Industries is used, wherein the melt flow index is measured in accordance with ISO 1103 at 220° C. under a 10 kg load.

(B-2) Non-Graft Copolymer Resin

Methyl methacrylate-acrylonitrile-styrene graft copolymer (Brand name: AP-CH) which has a weight-average molecular weight of 85,000 g/mol and a melt flow index of 50 g/10 min from Cheil Industries is used, wherein the melt flow index is measured in accordance with ISO 1103 at 220° C. under a 10 kg load.

(B-3) Non-Graft Copolymer Resin

Polymethyl methacrylate (Brand name: TP-160) which has a weight-average molecular weight of 85,000 g/mol and a melt flow index of 16 g/10 min from Cheil Industries is used, wherein the melt flow index is measured in accordance with ISO 1103 at 220° C. under a 10 kg load.

(B-4) Non-Graft Copolymer Resin

Styrene-acrylonitrile copolymer resin (Brand name: HF-5660) which comprises acrylonitrile in an amount of 15% by weight, has a weight-average molecular weight of 140,000 g/mol, and has a melt flow index of 5.5 g/10 min from Cheil Industries is used, wherein the melt flow index is measured in accordance with ISO 1103 at 220° C. under a 5 kg load.

(C) Siloxane Impact Reinforcing Agent

Polymethylsiloxane which has a viscosity of 90 to 100 cp from Nippon Unicar is used.

(E) Additives

As an antioxidant, Irganox 1076 from Ciba in an amount of 0.3 parts by weight is used. As an inner lubricant, ethylene bis stearamide in an amount of 0.2 parts by weight is used. As an external lubricant, magnesium stearate in an amount of 0.3 parts by weight is used. Carbon black in an amount of 0.2 parts by weight is used.

### EXAMPLES 1 TO 5 AND COMPARATIVE EXAMPLES 1 TO 9

After mixing the components and additives in the amounts set forth below in Table 1, the compositions are fed at a rate of 60 kg/hr and extruded at 210° C. using a twin extruder having screw rpm 250, diameter 45 mm, and L/D=36, and the extruded product is prepared in the form of pellets. The pellets are dried at 80° C. for four hours, and then specimens sized 2.2 mm×10 mm×6 mm are prepared by injection molding at 220° C. The physical properties of the prepared specimens are measured using the methods described below, and the results are presented in Table 1 below.

(1) Impact strength: Notch Izod impact strength is measured in accordance with ASTM D256 using a specimen with a ⅛ inch thickness.

(2) Flow index (g/10 min): The melt flow index is measured in accordance with ISO 1103, at 220° C. under a 10 kg load.

(3) R-Hardness: The R-hardness is measured in accordance with ASTM D785.

(4) Pencil hardness: The pencil hardness is measured by applying 500 g load 5 times to a surface of a test sample having a size of 3 mm×10 mm×10 mm in accordance with JIS (Japanese Industry Standard) K5401 at 23° C., and checking the surface of the sample for scratches with the naked eye. If two or more scratches are observed, the test is repeated with a pencil of one grade lower hardness. The results are reported on a scale of 4B to 7H.

(5) Cloudy white phenomenon at low temperature: A color chip specimen having a thickness of 3 to 4 mm is left inside a chamber at −30° C. for 12 hours, and thereafter the cloudy white phenomenon is judged with the naked eye. The following scale is used to rate the cloudiness of the specimen: ⊙: not occurred, O: occurred slightly, X: occurred severely.

TABLE 1

| | Examples | | | | | Comparative Examples | | | | | | | | |
|---|---|---|---|---|---|---|---|---|---|---|---|---|---|---|
| | 1 | 2 | 3 | 4 | 5 | 1 | 2 | 3 | 4 | 5 | 6 | 7 | 8 | 9 |
| (A-1) | 30 | 35 | 25 | 30 | 42 | — | 10 | 20 | — | — | 15 | 20 | 30 | 60 |
| (A-2) | — | — | 5 | 5 | 8 | — | — | — | 10 | 20 | — | — | 5 | — |
| (B-1) | 40 | 45 | 40 | 40 | 30 | — | 60 | 55 | 60 | 55 | — | — | 40 | 25 |
| (B-2) | 20 | 10 | 20 | 25 | 10 | — | 20 | 15 | 20 | 15 | — | — | 25 | 10 |
| (B-3) | 10 | 10 | 10 | 10 | 10 | 100 | 10 | 10 | 10 | 10 | 30 | 10 | 10 | 5 |
| (B-4) | — | — | — | — | — | — | — | — | — | — | 55 | 70 | — | — |
| (C) | 0.005 | 0.005 | 0.005 | 0.005 | 0.005 | — | 0.005 | 0.005 | 0.005 | 0.005 | 0.005 | 0.005 | — | 0.005 |
| Impact Strength | 16 | 18 | 15 | 17 | 19 | 2 | 5 | 12 | 5 | 10 | 8 | 11 | 8 | 21 |
| (Kgf · cm/cm) | | | | | | | | | | | | | | |
| Melt Flow | 17 | 14 | 12 | 11.5 | 8.0 | 16 | 28 | 22 | 30 | 24 | 23 | 33 | 11.5 | 4 |
| Index (g/10 min) | | | | | | | | | | | | | | |
| R-Hardness | 108 | 104 | 109 | 105 | 100 | 120 | 117 | 113 | 118 | 115 | 113 | 101 | 105 | 95 |
| Pencil Hardness | F | HB | F | F | HB | 3H | H | F | H | H | F | HB | F | 2B |
| Cloudy White at | ◯ | ⊙ | ⊙ | ⊙ | ⊙ | ⊙ | X | X | X | X | X | X | ⊙ | ⊙ |
| Low temperature | | | | | | | | | | | | | | |

⊙: not occurred, ◯: occurred slightly, X: occurred severely

As shown in the Table 1, examples 1-5 exemplifying the present invention exhibit excellent impact strength, fluidity, and scratch resistance. In addition, the cloudy white phenomenon at a low temperature is improved.

Comparative Example 1 using only polymethyl methacrylate exhibits poor impact strength, and is expected to have poor injection moldability. Comparative Examples 2 to 5 which include methyl methacrylate-acrylonitrile-butadiene-styrene graft copolymer in an amount of less than 30 parts by weight exhibits poor impact strength, and the cloudy white phenomenon at a low temperature is severe.

Comparative Example 6 using a scratch resistance resin composition (Brand name: SF-0505H) which is an alloy of g-MABS, PMMA, and SAN from Cheil Industries exhibits poor impact strength, and the cloudy white phenomenon at a low temperature is severe. Comparative Example 7 using a scratch resistance resin composition (Brand name: SF-0505HW) which is an alloy of g-MABS, PMMA, and SAN from Cheil Industries exhibits poor impact strength and scratch resistance, and the cloudy white phenomenon at a low temperature is severe.

Comparative Example 8 which does not include siloxane impact reinforcing agent exhibits significantly reduced impact strength. Comparative Example 9 which includes g-MABS in excess exhibits reduced fluidity and scratch resistance.

Many modifications and other embodiments of the invention will come to mind to one skilled in the art to which this invention pertains having the benefit of the teachings presented in the foregoing description. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A thermoplastic resin composition comprising;
(A) a graft copolymer resin comprising a core comprising a rubber polymer; and a shell formed by graft polymerization of acrylic acid alkyl ester monomer, methacrylic acid alkyl ester monomer, or a combination thereof with unsaturated nitrile monomer and aromatic vinyl monomer on a surface of the core;
(B) a non-graft copolymer resin comprising a copolymer which is formed by polymerizing acrylic acid alkyl ester monomer, methacrylic acid alkyl ester monomer, or a combination thereof with aromatic vinyl monomer and unsaturated nitrile monomer; and a (co)polymer which is formed by polymerizing acrylic acid alkyl ester monomer, methacrylic acid alkyl ester monomer or a combination thereof; and
(C) a siloxane impact reinforcing agent;
wherein the graft copolymer resin (A) comprises a first graft copolymer resin including a rubber polymer with an average particle size of about 0.18 to about 0.30 μm, a second graft copolymer including a rubber polymer with an average particle size of about 0.10 to about 0.17 μm, or a combination thereof.

2. The thermoplastic resin composition of claim 1, comprising the graft copolymer resin (A) in an amount of about 30 to about 50 parts by weight; the non-graft copolymer resin (B) in an amount of about 50 to about 75 parts by weight; and the siloxane impact reinforcement agent (C) in an amount of about 0.001 to about 0.01 parts by weight, based on the total weight of (A), (B) and (C).

3. The thermoplastic resin composition of claim 2, wherein the graft copolymer resin (A) includes the first graft copolymer resin in an amount of about 60 to about 99% by weight;
and the second graft copolymer in an amount of about 1 to about 40% by weight, based on the total weight of the graft copolymer resin (A).

4. The thermoplastic resin composition of claim 1, wherein the rubber polymer comprises butadiene rubber, acrylic rubber, ethylene-propylene copolymer rubber, butadiene-styrene copolymer rubber, acrylonitrile-butadiene copolymer rubber, isoprene rubber, ethylene-propylene-diene terpolymer rubber, polyorganosiloxane-polyalkyl(meth)acrylate rubber complex, or a combination thereof.

5. The thermoplastic resin composition of claim 1, wherein the shell comprises an inner shell and an outer shell, and wherein the outer shell includes a unit derived from an acrylic acid alkyl ester monomer, methacrylic acid alkyl ester monomer, or a combination thereof.

6. The thermoplastic resin composition of claim 5, wherein the inner shell is obtained through polymerization of the unsaturated nitrile monomer and the aromatic vinyl monomer; and wherein the outer shell is obtained through polymerization of the acrylic acid alkyl ester monomer, the methacrylic acid alkyl ester monomer, or a combination thereof.

7. The thermoplastic resin composition of claim 5, wherein the inner shell is obtained through polymerization of the acrylic acid alkyl ester monomer, the methacrylic acid alkyl ester monomer, or a combination thereof with the unsaturated nitrile monomer and the aromatic vinyl monomer; and wherein the outer shell is obtained through polymerization of the acrylic acid alkyl ester monomer, the methacrylic acid alkyl ester monomer, or a combination thereof with the unsaturated nitrile monomer and the aromatic vinyl monomer.

8. The thermoplastic resin composition of claim 1, wherein the graft copolymer resin (A) comprises the core in an amount of about 30 to about 70% by weight; a unit derived from the acrylic acid alkyl ester monomer or methacrylic acid alkyl ester monomer in an amount of about 15 to about 55% by weight; a unit derived from the unsaturated nitrile monomer in an amount of about 1 to about 5% by weight; and a unit derived from the aromatic vinyl monomer in an amount of about 5 to about 35% by weight, based on the total weight of the graft copolymer resin (A).

9. The thermoplastic resin composition of claim 1, wherein the graft copolymer resin (A) is a methyl methacrylate-acrylonitrile-butadiene-styrene graft copolymer.

10. The thermoplastic resin composition of claim 1, wherein the degree of grafting of the graft copolymer resin (A) is about 30 to about 70%.

11. The thermoplastic resin composition of claim 1, wherein the copolymer which is formed by polymerizing the acrylic acid alkyl ester monomer and/or methacrylic acid alkyl ester monomer, aromatic vinyl monomer, and unsaturated nitrile monomer of the non-graft copolymer resin (B) is methyl methacrylate-styrene-acrylonitrile copolymer, and wherein the (co)polymer which is formed by polymerizing the acrylic acid alkyl ester monomer, methacrylic acid alkyl ester monomer, or a combination thereof is polymethylmethacrylate.

12. The thermoplastic resin composition of claim 11, wherein the methyl methacrylate-styrene-acrylonitrile copolymer comprises a low fluidity methyl methacrylate-styrene-acrylonitrile copolymer with a weight-average molecular weight of more than about 100,000 g/mol and about 150,000 g/mol or less and a high fluidity methyl methacrylate-styrene-acrylonitrile copolymer with a weight-average molecular weight of about 50,000 to about 100,000 g/mol.

13. The thermoplastic resin composition of claim 11, wherein the non-graft copolymer resin (B) comprises the methyl methacrylate-styrene-acrylonitrile copolymer in an amount of about 50 to about 99% by weight; and the polymethylmethacrylate in an amount of about 1 to about 50% by weight.

14. The thermoplastic resin composition of claim 12, wherein the non-graft copolymer resin (B) comprises the low fluidity methyl methacrylate-styrene-acrylonitrile copolymer in an amount of about 30 to about 90% by weight; the high fluidity methyl methacrylate-styrene-acrylonitrile copolymer in an amount of about 5 to about 50% by weight; and the polymethylmethacrylate in an amount of about 1 to about 30% by weight.

15. The thermoplastic resin composition of claim 1, wherein the siloxane impact reinforcing agent (C) comprises polydimethylsiloxane, polymethylphenylsiloxane, polydiphenylsiloxane, or a combination thereof.

16. The thermoplastic resin composition of claim 1, wherein the siloxane impact reinforcing agent has a viscosity of about 40 to about 150 cp.

17. The thermoplastic resin composition of claim 1, wherein the thermoplastic resin composition further includes an additive selected from the group consisting of dyes, pigments, antioxidants, flame retardants, fillers, stabilizers, lubricants, antimicrobial agents, release agents, carbon black, and combinations thereof.

18. The thermoplastic resin composition of claim 1, wherein the thermoplastic resin composition has a Notch Izod impact strength of about 15 to about 20 kgf·cm/cm, wherein the Notch Izod impact strength is measured using a specimen with a 3.715 mm thickness in accordance with ASTM D256.

19. The thermoplastic resin composition of claim 1, wherein the thermoplastic resin composition has a melt flow index of about 8 to about 20 g/10 min, wherein the melt flow index is measured in accordance with ISO 1103 at 220° C. and a 10 kg load.

20. The thermoplastic resin composition of claim 1, wherein the thermoplastic resin composition has a R-hardness of about 100 to about 110, wherein the R-hardness is measured in accordance with ASTM D785.
